(19) United States
(12) Patent Application Publication
(10) Pub. No.: US 2024/0343540 A1
(43) Pub. Date: Oct. 17, 2024

(54) Module

(71) Applicant: VETTER Industrie GmbH, Burbach (DE)

(72) Inventors: Arnold Vetter, Wilnsdorf (DE); Tobias Weyl, Neunkirchen (DE); Carsten Vogt, Neunkirchen (DE)

(73) Assignee: VETTER Industrie GmbH, Burbach (DE)

(21) Appl. No.: 18/634,124

(22) Filed: Apr. 12, 2024

(30) Foreign Application Priority Data
Apr. 14, 2023 (DE) 10 2023 109 415
Apr. 4, 2024 (EP) 24168411

(51) Int. Cl. B66F 9/075; H04N 23/51; H04N 23/57

(52) U.S. Cl. CPC B66F 9/0755; B66F 9/07504; H04N 23/51; H04N 23/57

(57) ABSTRACT

The invention relates to a module with a housing for fastening in particular to a fork carriage of an industrial truck. Within the housing 110, a mounting bracket 130 is mounted for holding at least one functional unit 120. According to the invention, an alternative design for the mounting bracket is proposed in order to be able to position the mounting bracket with the functional unit in different degrees of freedom within the housing. For this purpose, the present invention provides that in addition to the fastening screws 134, with which the mounting bracket is screwed from the inside to the housing wall 112 110, adjusting screws are also provided in order to be able to adjust the distance between the mounting bracket 130 and the housing wall 112 110 at specific points and thus also to variably adjust the different degrees of freedom.

### CROSS-REFERENCE TO RELATED APPLICATIONS

This application claims the benefit of German Patent Application DE 10 2023 109 415, filed on Apr. 14, 2023, and of European Patent Application EP 24168411, filed on Apr. 4, 2024, the contents of which are incorporated in their entireties by reference.

### TECHNICAL FIELD

The disclosure relates to a module with a housing. The module is configured to be fastened to a fork carriage for forks of an industrial truck. Furthermore, the disclosure relates to a fork carriage with the module, an industrial truck with the fork carriage, and to a method for aligning a mounting bracket within the housing of the module.

### BACKGROUND

A module for attachment to a fork carriage on an industrial truck is generally known, e.g. from the German patent application publication DE 10 2019 118 756 A1. Within the housing disclosed therein, a mounting bracket in the form of a slide is arranged for holding at least one functional unit in the form of a sensor. The sensor can be, for example, a radar sensor or a camera or an ultrasonic sensor. The sensor can be moved/adjusted in a vertical direction using the slide. In addition, the sensor can be tilted relative to the horizontal and/or rotated relative to a rotation axis. The sensor is used to monitor an area in front of the forks of an industrial truck, in particular a forklift truck.

### SUMMARY

The present application proposes an improved design for a mounting bracket, also in conjunction with a housing, to realize different degrees of freedom in a module, a fork carriage, and an industrial truck. The application also proposes an improved method for aligning the mounting bracket.

The module includes an opening in a housing wall through which a functional unit communicates with the environment. At least one hole is provided in the housing wall for introducing at least one fastening screw. The mounting bracket can be screwed to the housing wall inside the housing with the aid of the at least one fastening screw which is guided through the hole. At least one adjusting screw is screwed into the mounting bracket on its side facing the housing wall, by means of which the mounting bracket is supported against the housing wall when the mounting bracket is screwed to the housing wall with the fastening screws.

The adjusting screws are provided in the space between the mounting bracket and the housing wall and thus define the distance of the mounting bracket to the housing wall at a point. In other words: The mounting bracket is supported from the inside against the housing wall by the adjusting screws. The adjusting screws therefore press against the housing wall at certain points/support themselves against the housing wall. By screwing the adjusting screws to a greater or lesser extent into an associated threaded hole in the mounting bracket, the distance of the mounting bracket to the housing wall at a point can advantageously be variably adjusted. Depending on where the at least one adjusting screw is provided on the mounting bracket, it is possible, by varying the respective point distance, to advantageously variably adjust the angle of inclination of the mounting bracket relative to the housing wall/relative to the horizontal as a first degree of freedom and/or the angle of rotation of the mounting bracket about an axis of rotation, preferably about the vertical y-axis, as a second degree of freedom.

According to a first embodiment, the at least one hole for passing through the fastening screw is designed as an elongated hole, preferably aligned in the vertical direction. This has the advantage that the fastening screws can be moved and locked together with the mounting bracket in the at least one elongated hole (third degree of freedom).

According to a second embodiment, the head of the adjusting screw is wider than the clear width of the elongated hole. The at least one threaded hole for the at least one adjusting screw is arranged on the mounting bracket next to a threaded hole for the fastening screw. The adjusting screw, screwed into its threaded hole, is supported along inner edges of the elongated hole on the housing wall when the fastening screw—guided through the elongated hole—is screwed into its threaded hole. The adjusting screw, even though arranged entirely inside the housing, can be turned from outside the housing because a screwdriver can access and turn the adjusting screw through the elongated hole. This is particularly practical because the distance, the angle of inclination, and/or the rotational position of the mounting bracket in relation to the housing, in particular the housing wall, can be variably adjusted from outside the housing due to this design.

According to a further embodiment, the mounting bracket has a receiving space for receiving the functional unit. The edge or the wall of the receiving space as part of the mounting bracket is made of an elastic material, preferably with a compression joint for clamping the functional unit in a desired rotational angle position about the z-axis in the receiving space when a force acts on the edge or the wall of the receiving space.

According to a further embodiment, the elastic edge or the elastic wall of the receiving space is designed such that it protrudes below a base level of the mounting bracket in the relaxed state of the mounting bracket. This has the advantage that when the fastening screws are tightened and the mounting bracket is pressed against the housing wall, a force is simultaneously exerted on the edge or the wall of the receiving space, so that the functional unit is clamped in the receiving space.

According to a further embodiment, a plurality of holes for the fastening screws can be provided distributed in the housing wall for positioning the mounting bracket at different locations/positions within the housing.

The functional unit is preferably an optical device that communicates with its surroundings and with the surroundings of the housing via electromagnetic radiation, in particular light, through an opening in the housing. The optical functional device can be, for example, a light source, in particular a laser light source for emitting a light beam, a camera, and/or a sensor, for example a motion sensor or a distance sensor. A radio module with a transmitting and/or receiving unit for preferably bidirectional communication, for example via Bluetooth, ZigBee, or Wi-Fi, can preferably be assigned to the functional unit.

The laser light source can be designed as a line laser or as a cross laser, each of which is visible when projected onto an object to be moved. Depending on the application, it may be useful to project a line or a cross onto the object.

A voltage supply unit is typically arranged in the housing for providing an electrical supply voltage, in particular for the functional unit. The voltage source can be designed either in the form of an accumulator or in the form of a tap for an external voltage supply, for example the voltage supply of the industrial truck.

According to a further embodiment, the mounting bracket is made of an elastic material at least in the area of the threaded holes for the fastening screws and/or in the area of the threaded holes for the adjusting screws. This offers the advantage of avoiding mechanical stresses within the mounting bracket, which would otherwise inevitably occur if the mounting bracket were clamped against the housing wall by the fastening screws, while at the same time being adjusted with respect to the degrees of freedom described above by the adjusting screws.

The disclosure also relates to a fork carriage for the forks of an industrial truck. The module as described is fastened to the fork carriage. The disclosure further relates to an industrial truck with said fork carriage, and to a method for aligning the mounting bracket on the housing wall in the module. The advantages of these solutions correspond to those mentioned above with reference to the module.

### BRIEF DESCRIPTION OF THE DRAWINGS

FIG. 1 shows a module, attached to a fork carriage for forks of an industrial truck.

FIG. 2 shows a view of the housing wall from the outside.

FIG. 3 shows a view into the interior of the housing.

FIGS. 4a and 4b show the mounting bracket in two different perspective views.

FIG. 5 shows a cross section through the mounting bracket, screwed from the inside to the housing wall with adjusting screws fully screwed in.

FIG. 6 shows an analogous representation to FIG. 5, but with the adjusting screws partially unscrewed.

FIG. 7a shows a cross-section through the mounting bracket in the relaxed state.

FIG. 7b shows the mounting bracket in a clamped state screwed against the housing wall.

FIG. 8 shows a view from the outside of the housing wall to illustrate the variable displaceability of the mounting bracket within the housing.

FIG. 9 shows a cross-sectional view through the mounting bracket screwed to the housing wall to illustrate its vertical displaceability.

FIG. 10 shows a cross-section through the mounting bracket, screwed to the housing with built-in functional unit.

FIG. 11 shows the module, mounted on a fork carriage, in a perspective view.

FIG. 12 shows a top view of the fork carriage with forks and the module.

FIG. 13 shows an industrial truck with the fork carriage to which the forks and the module are attached.

### DETAILED DESCRIPTION

The invention is described in detail below in the form of exemplary embodiments with reference to the figures. In all figures, the same technical elements are designated by the same reference symbols.

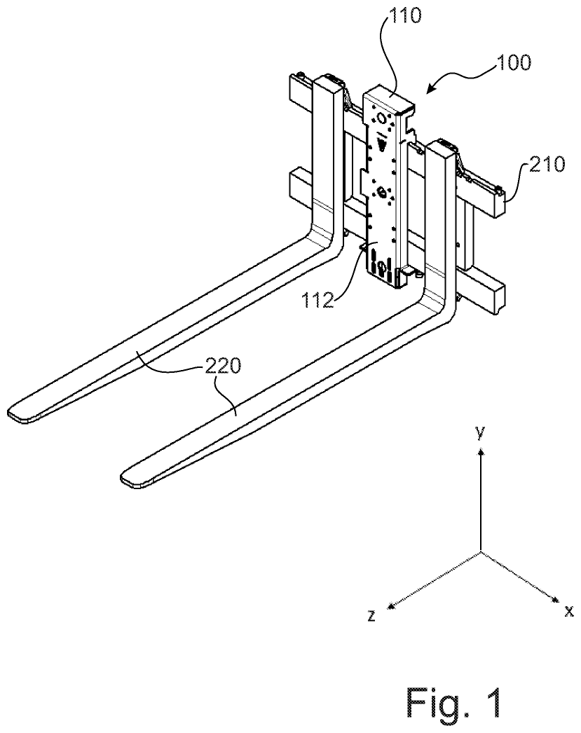

FIG. 1 shows the module 100, with the housing 110 attached centrally between two forks 220 on a fork carriage 210.

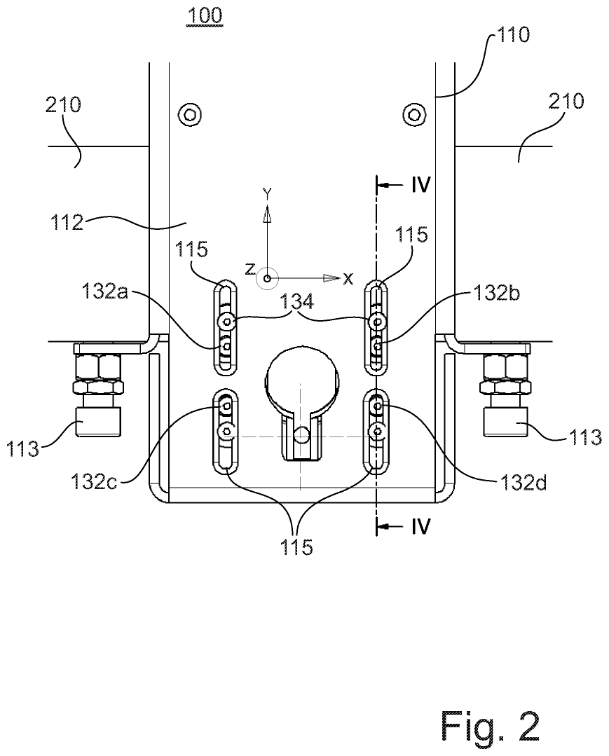

FIG. 2 shows the lower portion of the housing 110 of FIG. 1 in detail. FIG. 2 shows the view from the outside of the housing wall 112. The housing 110 or the module 100 is screwed to the fork carriage 210 from below, for example, with screws 113. Holes 115 in the form of elongated holes can be seen in the housing wall 112. Fastening screws 134 for fastening a mounting bracket in the interior of the housing can be inserted through the elongated holes. The mounting bracket is used to hold a functional unit that communicates with the environment via an opening 118 in the housing wall 112.

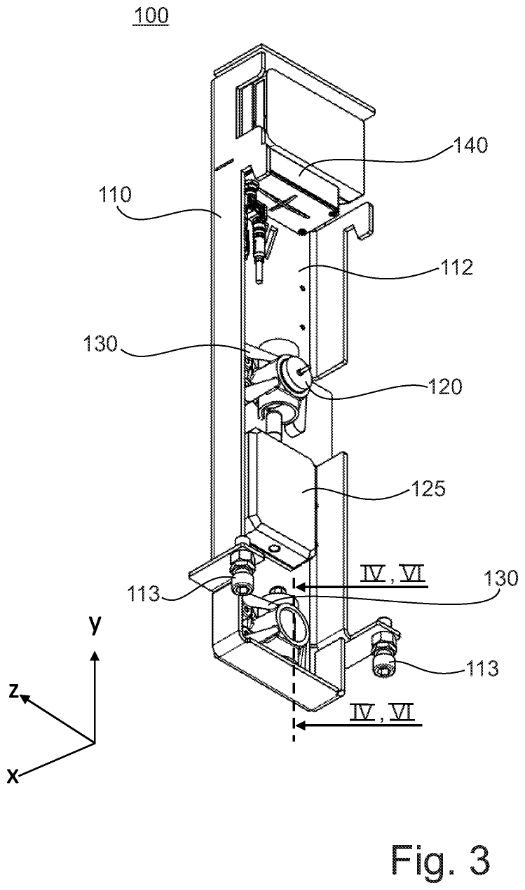

FIG. 3 shows a view into the interior of the opened housing 110 with the housing wall 112. A voltage supply unit 140, two mounting brackets 130 and various functional units 120 are arranged inside the housing. A functional unit in the form of a camera or a laser device is carried by the central mounting bracket 130. A radio module 125, typically equipped with a transmitting and/or receiving unit for preferably bidirectional communication, for example via Bluetooth, ZigBee, or Wi-Fi, is operatively connected to the functional unit 120. The radio module is used to transmit signals from the functional unit to the environment or to receive information from the environment.

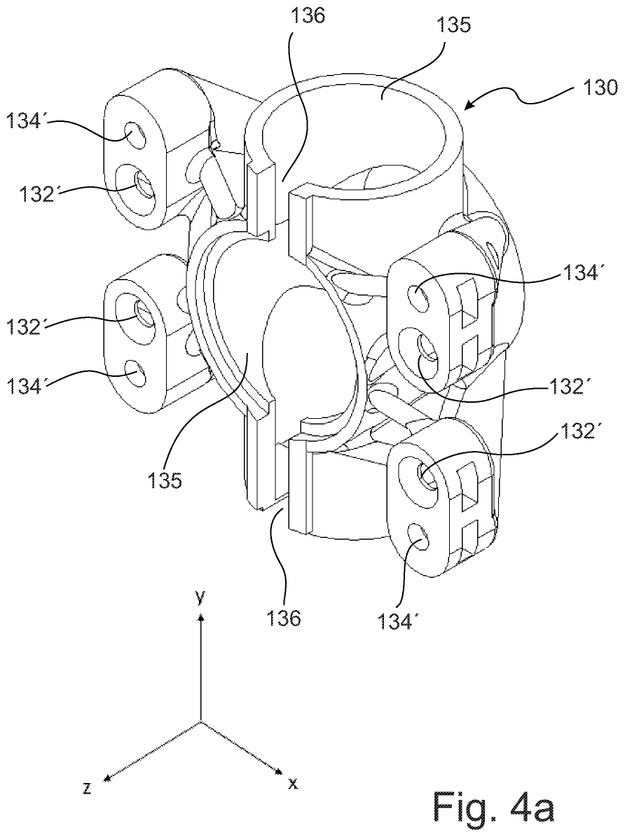

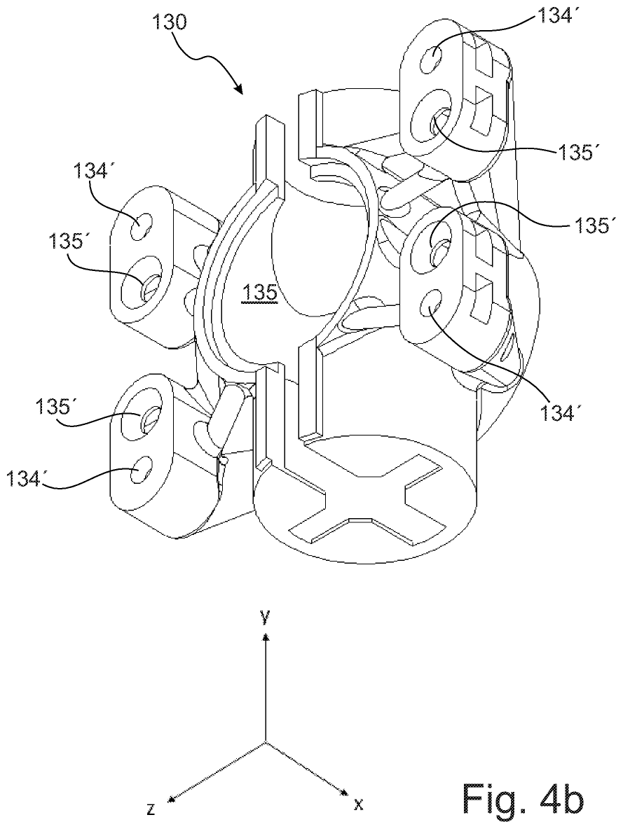

FIGS. 4a and 4b show the mounting bracket 130 in different perspective views. A receiving space 135 can be seen for receiving and holding the functional unit 120. In addition, threaded holes 132′, 134′ can be seen, on the one hand for the fastening screws 134 and on the other hand for adjusting screws 132.

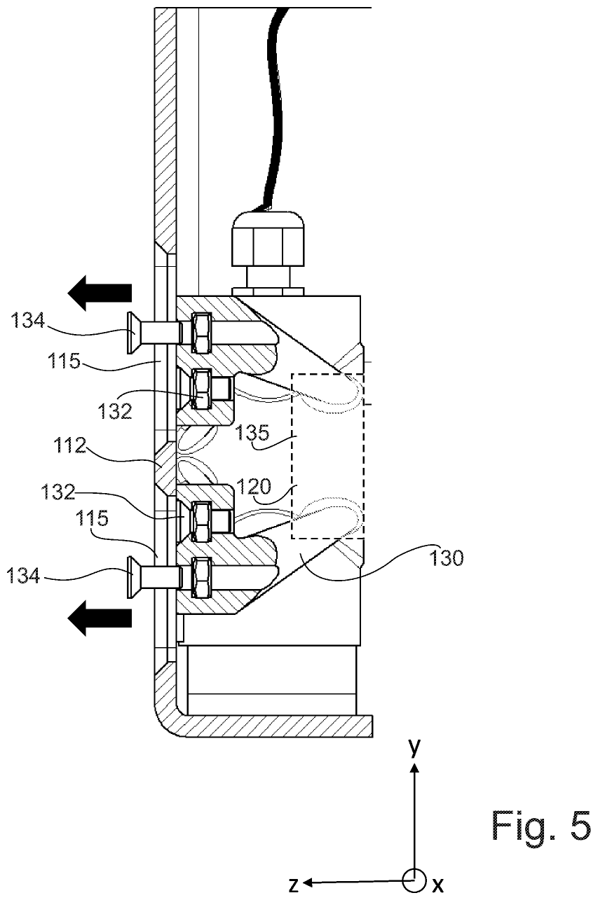

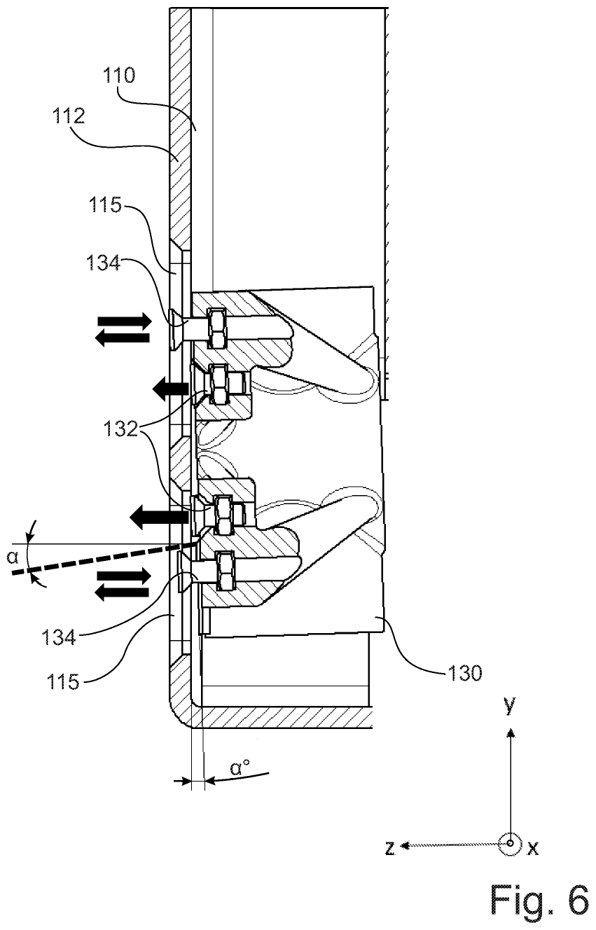

FIGS. 5 and 6 show the mounting of the mounting bracket 130 from the inside to the housing wall 112, in detail. The mounting bracket 130 is firmly screwed to the housing wall 112 inside the housing 110 by at least one fastening screw 134. The at least one fastening screw 134 is guided from the outside through the hole 115. The mounting bracket is supported against the housing wall 112 via the adjusting screws 132, which are arranged on the side of the mounting bracket facing the housing wall 112. This applies in particular when the mounting bracket 130 is screwed to the housing wall 112 with the fastening screws 134.

FIG. 5 shows the screw connection of the mounting bracket 130 against the housing wall 112 without set inclination angle α.

Due to the adjusting screws 132, as illustrated in FIGS. 5 and 6, it is possible to variably adjust the angle of inclination α of the mounting bracket 130 and thus of the functional unit 120, which is detachably but firmly mounted therein, relative to the horizontal and, if necessary, to lock it. For this purpose the following steps must be carried out:
loosening the fastening screws 134 and thus the mounting bracket 130—with or without the functional unit 120—from the housing wall 112;
turning at least one of the adjusting screws 132 so that the mounting bracket is inclined relative to the housing wall 112 according to a desired angle of inclination a and/or angle of rotation β; and
tightening the fastening screws 134 and thus locking the mounting bracket 130 in the inclined and/or rotated position relative to the housing wall 112.

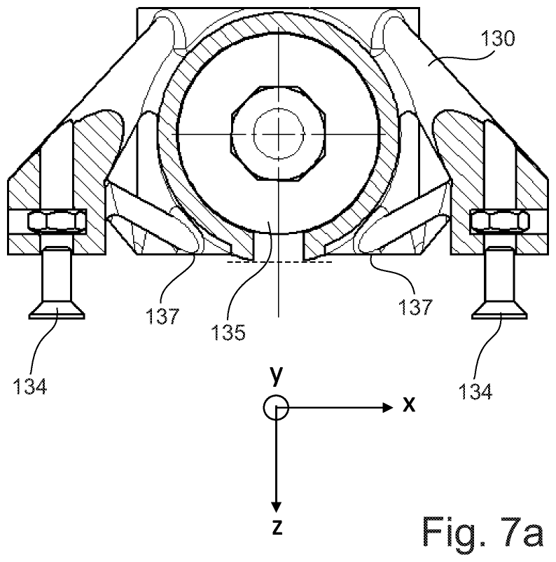

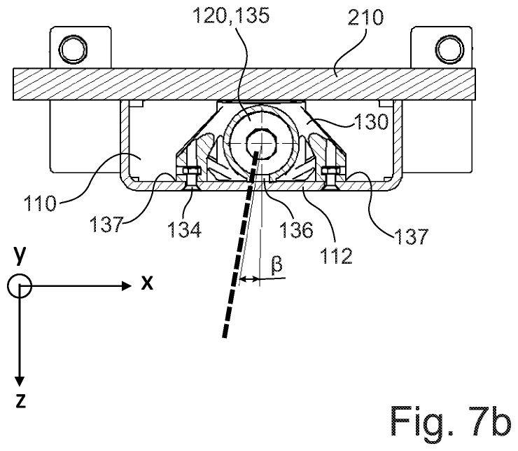

FIG. 7a shows a top view of a horizontal cross section through the mounting bracket 130. The mounting bracket 130 has a receiving space 135 extending in the y-direction for receiving the functional unit 120. In the relaxed state of the mounting bracket 130 shown in FIG. 7a, the elastically formed edge and/or the elastically formed wall of the receiving space 135 protrudes below a base level 137 of the mounting bracket 130. The base level 137 defines the support surface of the mounting bracket 130, against the housing wall 112, unless an inclination angle α is set.

FIG. 7b shows exactly this situation. It can then be seen that the elastic edge or the elastic wall of the receiving space 135 at least no longer projects downwards beyond the base level 137, but that the edge or the wall is instead pressed against the housing wall 112 and thus at the level of the base level due to the tensile forces applied by the fastening screws 134. The compression joint 136—if present—is at least partially compressed. Due to this force acting on the edge/the wall of the receiving space 135, it is possible to clamp the functional unit 120 in a desired rotational angle position ß about the y-axis in the receiving space 135 in a rotationally secure manner. The necessary method steps are as follows:
loosening the fastening screws 134 and thus the mounting bracket with the functional unit 120 from the housing wall 112, so that the elastic edge or the elastic wall of the receiving space 135 in the relaxed state extends below the base level 137 of the mounting bracket 130, whereby the receiving space 135 is widened and the functional unit 120 becomes movable in the receiving space;
rotating the functional unit 120 in the receiving space 135 to the desired angle of rotation position β about the y-axis or to the desired angle of rotation position γ about the z-axis; and
tightening the fastening screws 134 and thus pressing the edge or the wall of the receiving space 135 against the housing wall 112 under the action of force, whereby the functional unit 120 is clamped in the receiving space of the mounting bracket in a rotationally secure manner in the desired rotation angle position β, γ.

Alternatively, the angle of rotation β can also be adjusted by adjusting the adjusting screws 132 accordingly, analogous to the adjustment of the angle of inclination α, as described above. The mounting bracket 130 is fastened to the housing wall 112 by a plurality of preferably four fastening screws 134. A plurality of preferably four adjusting screws 132 are fastened to a wall of the mounting bracket 130, further preferably arranged in the shape of a rectangle, as can be indirectly seen in FIG. 2. Depending on which of the four adjusting screws is changed, either the inclination angle α and/or the rotation angle β can be adjusted. Specifically, for example, to vary the angle of inclination α, either the upper adjusting screws 132a and 132b or the lower adjusting screws 132c and 132d must be pairwise changed in their setting. To change the angle of rotation position β, however, the pairs of left adjusting screws 132b and 132d or right adjusting screws 132a and 132c must be pairwise changed in their setting. A combined adjustment of all or individual adjusting screws is also possible; this can lead to a change in both the inclination angle α and the rotation angle position β.

As a result of a change in the setting of the adjusting screws, it can happen that the pressing force from the inside of the housing wall 112 against the edge or the wall of the receiving space 135 becomes too low to clamp the functional unit 120 in the receiving space 135 in a rotationally secure manner. In this case, in order to adjust the angle of rotation position β via the adjusting screws, it is necessary that the functional unit 120 is otherwise rotationally secured in the receiving space 135.

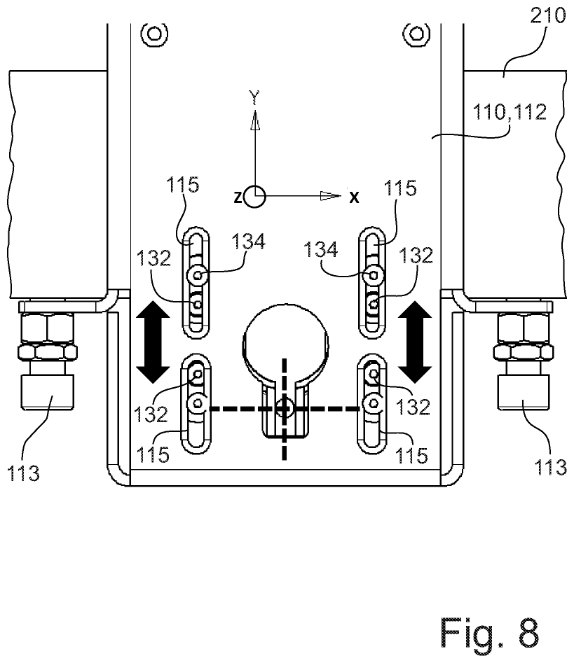

FIG. 8 shows a view from the outside of the housing wall 112 with the holes 115 for the fastening screws 134, formed in the form of elongated holes extending in the vertical direction y. As in FIGS. 5 and 6, it can also be seen in FIG. 8 that the head of the adjusting screws 132 is wider than the clear width of the elongated hole. The threaded hole/a nut for the adjusting screw 132 is arranged in the mounting bracket 130 next to a threaded hole for the fastening screw, which is likewise embodied by way of example in the form of a nut. The adjusting screw—screwed into its threaded hole—is supported is supported along inner edges of the elongated hole 115 when at the same time the fastening screw 134 is screwed into its threaded hole guided through the elongated hole. This is shown in FIGS. 2 and 8. The adjusting screws 132 can so be adjusted from outside of the housing, even though they are entirely inside the housing. Even when the housing is mounted on the fork carriage 210, this allows changing the angle of inclination α or the angle of rotation β, as described above.

At the same time, the elongated holes 115 in conjunction with the fastening screws 134 offer the advantage that the mounting bracket 130 and thus also the functional unit mounted therein can be displaced and locked in the y-direction, i.e., in the vertical direction. This is done by performing the following steps:
loosening the fastening screws 134 and thus the mounting bracket 130 from the housing wall 112;
moving the mounting bracket with or without the functional unit 120 in the direction of the longitudinal alignment of the elongated hole to a desired position, for example in the vertical direction; and
tightening the fastening screws 134 and thus locking the mounting bracket 130 in the desired position on the housing wall 112.

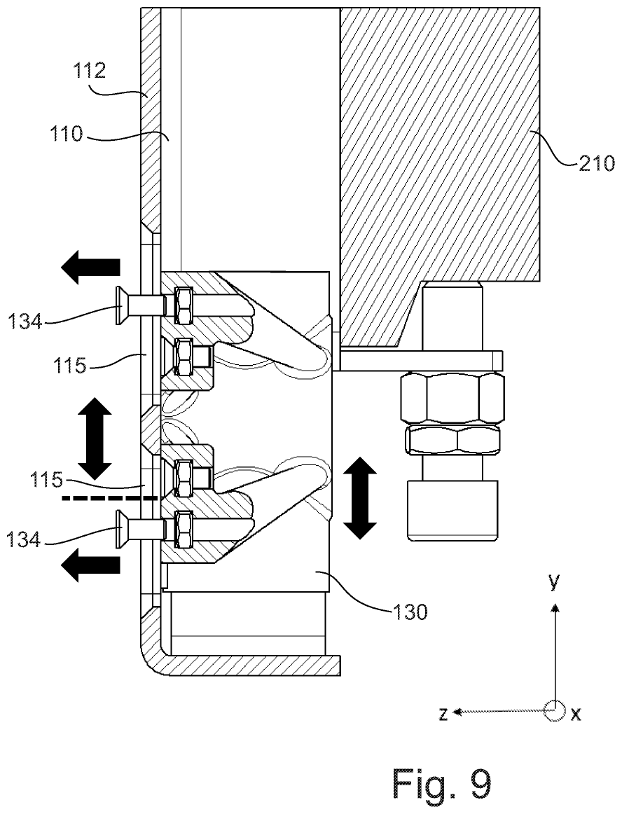

FIG. 9 illustrates this method in detail by the double arrows drawn in thick black.

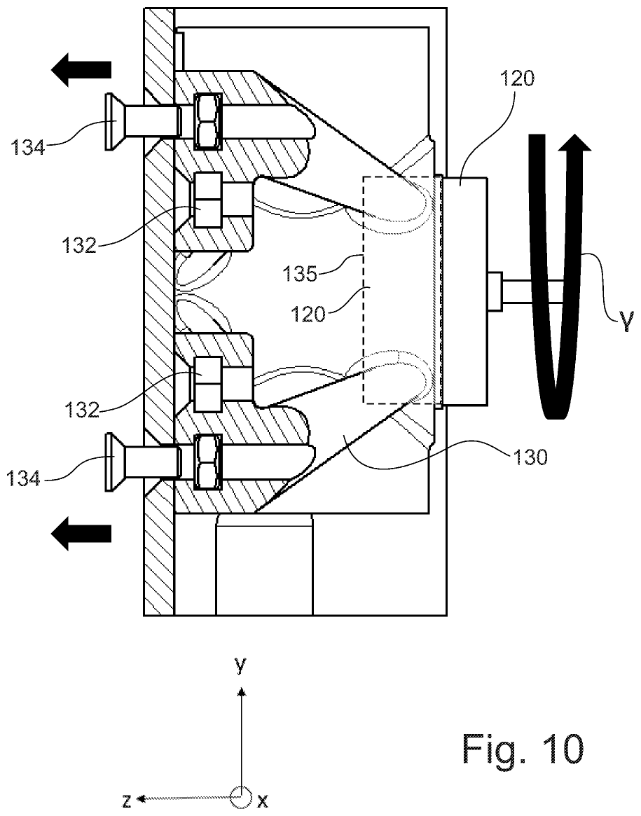

The receiving space 135 for the functional unit 120 can be aligned not only in the y-direction, as previously described, but also in the z-direction, as shown in FIG. 10. As described above with reference to FIGS. 7 and 8, the functional unit 120 can thus also be rotated about the z-axis to a desired angle of rotation position γ and locked there.

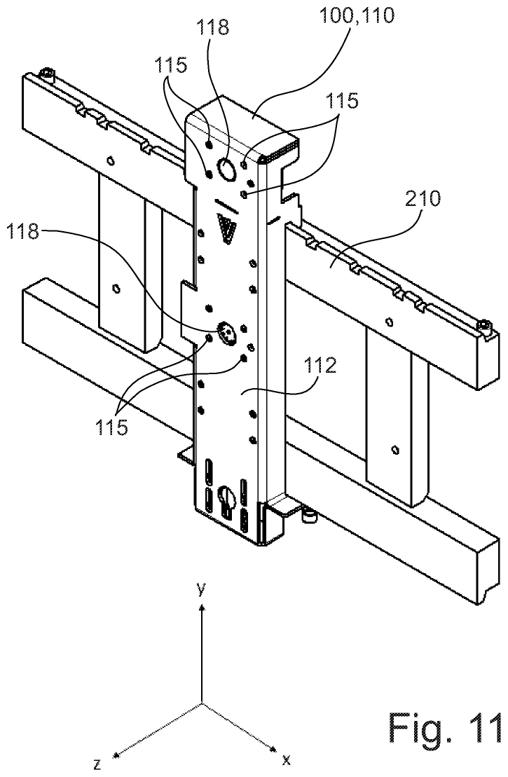

FIG. 11 shows the module and the housing 110 mounted on a fork carriage 210. The view from the outside of the housing wall 112 shows that the holes 115 for the fastening screws 134 for the mounting bracket 130 can be arranged distributed at different positions on the housing wall 112 in order to be able to position the mounting bracket 130 at these different positions. In the area of the holes 115, an opening 118 is then also to be provided through which, as mentioned, the functional unit 120 communicates from the inside of the housing to the outside with its environment.

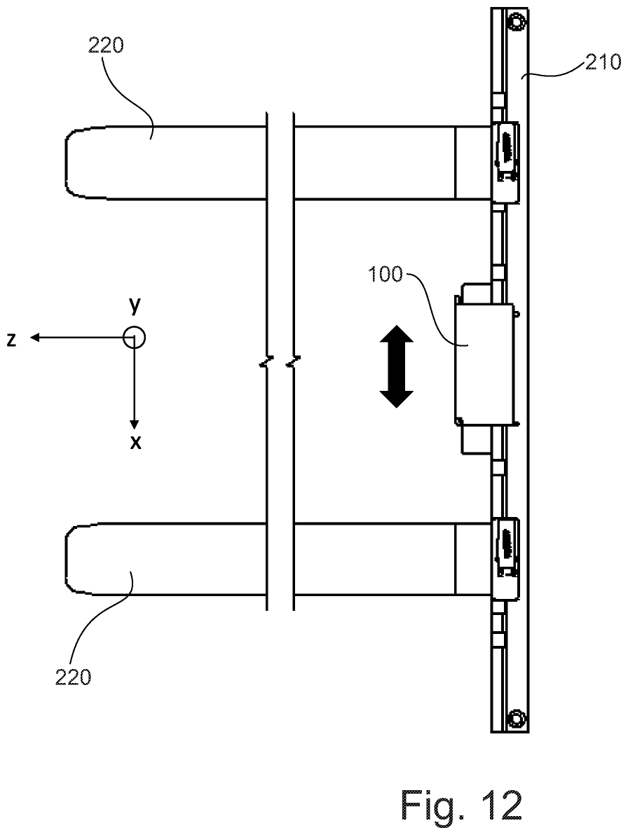

FIG. 12 shows a top view of the fork carriage 210 with the mounted forks 220 and the module 100/housing 110 preferably mounted centrally between the two forks. The double arrow indicates that the module can be variably positioned/moved and locked on the fork carriage 210 in the horizontal x direction.

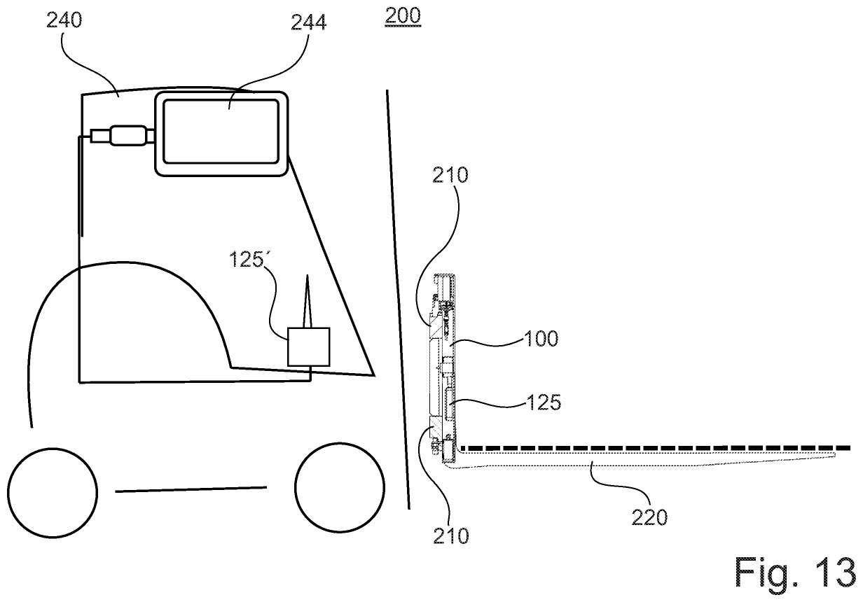

Finally, FIG. 13 illustrates the industrial truck 200, in the form of a forklift truck. The fork carriage 210 with the mounted module 100 and with forks 220 is shown on the industrial truck 200. The radio module 125 within the module 100 communicates with a radio module 125′ in the area of the driver's cab 240. The radio module 125′ is designed, for example, to output signals from a camera in the module 100 to a monitor 244, which is preferably arranged in the driver's cab 240, for the operator.

### LIST OF REFERENCE SYMBOLS

100 module
110 housing
112 housing wall
113 screw
115 holes, elongated holes
118 opening
120 functional unit
125 radio module
125′ radio module
130 mounting bracket
132 adjusting screws
132a-d adjusting screws
132′ threaded hole for adjusting screws
134 fastening screws
134′ threaded hole for fastening screws
135 receiving space
136 compression joint
137 basic level
140 voltage supply unit
200 industrial truck
210 fork carriage
220 forks
240 driver's cab
244 monitor
α tilt angle
β angle of rotation around y-axis
γ angle of rotation around z-axis

What is claimed is:

1. A module (100), comprising:
a housing (110) for fastening to a fork carriage (210) of an industrial truck (200);
a mounting bracket (130) arranged within the housing (110) for holding a functional unit (120);
an opening (118) in a housing wall (112) of the housing (110) through which the functional unit communicates with an environment;
a hole (115) extending through the housing wall (112) for guiding a fastening screw (134),
wherein the mounting bracket (130) can be screwed to the housing wall (112) inside the housing by the fastening screw (134) which is guided through the hole (115); and
an adjusting screw (132) that is screwed into the mounting bracket (130) on a side facing the housing wall,
wherein the mounting bracket is supported against the housing wall (112) by the adjusting screw (132) when the mounting bracket is screwed to the housing wall with the fastening screw.

2. The module according to claim 1,
wherein the hole (115) is a vertically aligned elongated hole.

3. The module according to claim 2,
wherein a head of the adjusting screw (132) is wider than a clear width of the elongated hole; and
wherein a threaded hole for the adjusting screw (132) is provided on the mounting bracket (130) next to a threaded hole for the fastening screw (134) in such a way that the adjusting screw, being screwed into its threaded hole, is supported along inner edges of the elongated hole (115) on the housing wall when the fastening screw (134), guided through the elongated hole, is screwed into its threaded hole.

4. The module (100) according to claim 1,
wherein the fastening screw (134) is part of a plurality of four fastening screws (134) by which the mounting bracket (130) is fastened to the housing wall (112), and/or
wherein the adjusting screw (132) is part of a plurality of four adjusting screws (132) by which the mounting bracket (130) is supported against the housing wall (112).

5. The module (100) according to claim 1,
wherein the mounting bracket (130) has a receiving space (135) extending in a y-direction for receiving the functional unit (120), and
wherein an edge or a wall of the receiving space (135) being part of the mounting bracket is made of an elastic material and includes a compression joint (136) for clamping the functional unit (120) in a desired rotational angle position (β) about a y-axis in the receiving space (135) when a force acts on the edge or the wall of the receiving space, or
wherein the mounting bracket (130) has a receiving space 135 extending in a z-direction for receiving the functional unit (120), and
wherein an edge or a wall of the receiving space (135) being part of the mounting bracket is made of an elastic material and includes a compression joint (136) for clamping the functional unit (120) in a desired rotational angle position (γ) about a z-axis in the receiving space (135) when a force acts on the edge or the wall of the receiving space.

6. The module according to claim 5,
wherein the edge or the wall of the receiving space (135) projects below a base level (137) of the mounting bracket (130) in a relaxed state of the mounting bracket.

7. The module (100) according to claim 1,
wherein the fastening screw (134) is part of a plurality of fastening screws (134), and
wherein the hole (115) is part of a plurality of holes (115) for the fastening screws (134), and
wherein the holes (115) are distributed in the housing wall (112) for positioning the mounting bracket at different locations within the housing.

8. The module (100) according to claim 1,
wherein the functional unit (120) is an optical device which communicates with the environment of the housing via light through an opening (118) in the housing (110),
wherein the optical device is a laser light source for emitting a light beam, a camera, a motion sensor, or a distance sensor; and
wherein the functional unit is operatively connected to a radio module (125, 125′) with a transmitting and/or receiving unit for bidirectional communication between the module and a driver's cab (240) of the industrial truck (200).

9. The module (100) according to claim 8,
wherein the laser light source is a line laser for emitting laser light as a horizontal line that is visible when projected onto an object, or
wherein the laser light source is a cross laser for emitting the laser light as a horizontal line and a perpendicular vertical line that are visible when projected onto an object.

10. The module (100) according to claim 1,
wherein a voltage supply unit (140) is arranged in the housing for providing an electrical supply voltage to the functional unit (130), and
wherein the voltage supply unit (140) is an accumulator or a tap for an external supply voltage of the industrial truck.

11. The module according to claim 1,
wherein the mounting bracket is made of an elastic material, at least in an area of threaded holes for the fastening screws (134) and/or threaded holes for the adjusting screws (132).

12. A fork carriage (210) for forks (220) of an industrial truck (200), comprising
the module (100) according to claim 1 fastened to the fork carriage (210).

13. The fork carriage (210) according to claim 12,
wherein two forks are attached to the fork carriage (210), and
wherein the module (100) is arranged centrally between the two forks (220).

14. The fork carriage (210) according to claim 12,
wherein the module (100) is horizontally displaceable on the fork carriage (210) in an x-direction and can be locked.

15. A forklift truck, comprising
the fork carriage (210) according to claim 12.

16. The industrial truck (200) according to claim 15,
wherein the functional unit (120) is a camera,
wherein the industrial truck (200) has a driver's cab (240) for driving the industrial truck by an operator, and
wherein a monitor (244) is provided in the driver's cab (240) for displaying images recorded by the camera (120) to the operator.

17. A method for aligning a mounting bracket (130) on a housing wall (112) in a module
fastened to a fork carriage (210) of an industrial truck (200),
wherein holes (115) for fastening screws (134) are provided in the housing wall (112),
wherein the mounting bracket (130) can be screwed to the housing wall (112) by the fastening screws (134), and
wherein the mounting bracket (130) is supported against the housing wall (112) from inside by adjusting screws (132),
comprising the following steps for adjusting an angle of inclination (α) of mounting bracket (130) relative to a z-axis and/or an angle of rotation (β) of the mounting bracket (130) about a y-axis:
loosening the fastening screws (134) and thus the mounting bracket (130) from the housing wall (112) of the housing (110);
turning at least one of the adjusting screws (132) so that the mounting bracket is inclined relative to the housing wall (112) of the housing (110) according to a desired angle of inclination (α) and/or a desired angle of rotation (β) in a desired inclined and/or desired rotated position; and
tightening the fastening screws (134) and thereby locking the mounting bracket (130) in the desired inclined and/or desired rotated position relative to the housing wall (112).

18. The method according to claim 17,
wherein turning at least one of the adjusting screws (132) is performed using a screwdriver from outside the housing (110) through the holes (115).

19. The method according to claim 17,
wherein the mounting bracket (130) has a receiving space (135) for receiving a functional unit (120),
wherein at least an edge or a wall of the receiving space (135) being part of the mounting bracket is made of an elastic material and includes a compression joint (136) for clamping the functional unit (120) in a desired rotational angle position (β) about the y-axis in the receiving space (135) when it extends in a y-direction, or in a desired rotational angle position (γ) when the receiving space (135) extends in a z-direction,
further comprising:
loosening the fastening screws and thus the mounting bracket with the functional unit (120) from the housing wall (112), so that the edge or the wall of the receiving space (135) in a relaxed state extends below a base level (137) of the mounting bracket (130), whereby the receiving space (135) is widened and the functional unit (120) becomes movable in the receiving space;
rotating the functional unit (120) in the receiving space (135) to the desired angle of rotation position (β) about the y-axis or to the desired angle of rotation position (γ) about the z-axis; and
tightening the fastening screws and thus pressing the edge or the wall of the receiving space (135) against the housing wall (112) under action of force, whereby the functional unit (120) is clamped in the receiving space of the mounting bracket in a rotationally secure manner in the desired angle of rotation position (β, γ).

20. The method according to claim 17,
wherein that the holes (115) for the fastening screws (134) are elongated vertical holes,
further comprising:
loosening the fastening screws (134) and thus the mounting bracket (130) from the housing wall (112);
vertically moving the mounting bracket to a desired position; and
tightening the fastening screws (134) and thus locking the mounting bracket (130) in the desired position on the housing wall (112).
